(19) United States
(12) Patent Application Publication
(10) Pub. No.: US 2013/0201159 A1
(43) Pub. Date: Aug. 8, 2013

(54) INFORMATION PROCESSING APPARATUS, INFORMATION PROCESSING METHOD, AND PROGRAM

(71) Applicant: Sony Corporation, Tokyo (JP)

(72) Inventor: Shinji Inamoto, Tokyo (JP)

(73) Assignee: Sony Corporation, Tokyo (JP)

(21) Appl. No.: 13/749,781

(22) Filed: Jan. 25, 2013

(30) Foreign Application Priority Data
Feb. 3, 2012 (JP) 2012-021892

(51) Int. Cl. G06F 3/041

(52) U.S. Cl. CPC G06F 3/0418
USPC 345/178

(57) ABSTRACT

There is provided an information processing apparatus including a position detecting unit detecting a contact position at which an input object has touched a touch panel, and a selecting unit selecting any one of a plurality of objects based on the contact position and a last contact position.

### BACKGROUND

The present disclosure relates to an information processing apparatus, an information processing method, and a program.

Along with the spread of smartphones and the expansion in network connectivity, technologies for treating a touch panel-equipped terminal as a controller for controlling a TV set, a game console, or the like have been provided. However, since hardware buttons are not present on a touch panel, it is easy for users to press the wrong button, especially in situations where the user is not looking at the controller, such as when playing a game. For this reason, when a user makes operations using a touch panel, the user will sometimes momentarily glance at the controller to prevent large positional displacements from occurring between the position of the button the user wishes to press and the position actually touched by the user. Note that the “buttons” referred to here are one example of objects.

Technologies for preventing such positional displacements include technologies that provide the user with a virtual haptic sensation through the use of vibration, for example. However, such technologies can only be applied in devices with a function for generating vibration. For normal devices, there is also a technology for enlarging and reducing the recognition regions used to recognize objects selected using a touch panel and a technology for shifting such regions.

As one example, there is a technology that shifts a recognition region for recognizing a selected object according to the position where an object is disposed (see for example Japanese Laid-Open Patent Publication No. 2011-175456). Since it is difficult to select an object disposed at a lower end of a touch panel of a copier, for example, this technology shifts the recognition region upward. If the recognition region is shifted in this way, an object may be selected even if the position touched by the user is displaced from the position of the object the user intended to select.

### SUMMARY

Although the technology disclosed in the cited publication is effective when the displacement between the position touched by the user and the position of the object the user wishes to select is constant, such displacement is sometimes not constant. For example, when a touch panel is used as a controller, since it is necessary to select objects multiple times in a short time without looking at the touch panel, the displacement may change. This means it is difficult to recognize the object the user intended to select by merely shifting the recognition region in a uniform manner.

Also, even if the recognition region is shifted in a uniform manner, there is the possibility that the position touched by the user will become increasingly displaced from an object position and that the user will touch a position midway between a plurality of objects, for example. Such possibility is especially high when a controller equipped with a touch panel is used since it is common for users to make operations without looking at the panel.

For the reasons given above, there is demand for a technology for improving accuracy when selecting a user's intended object. As examples, it is desirable to improve accuracy even when selecting a user's intended object when there is a large displacement between the position of an object and the position touched by the user and when the user touches a position midway between a plurality of objects.

According to an embodiment of the present disclosure, there is provided an information processing apparatus including a position detecting unit detecting a contact position at which an input object has touched a touch panel, and a selecting unit selecting any one of a plurality of objects based on the contact position and a last contact position.

Further, according to an embodiment of the present disclosure, there is provided an information processing method including detecting a contact position at which an input object has touched a touch panel, and selecting any one of a plurality of objects based on the contact position and a last contact position.

Further, according to an embodiment of the present disclosure, there is provided a program for causing a computer to function as an information processing apparatus, the information processing apparatus including a position detecting unit detecting a contact position at which an input object has touched a touch panel, and a selecting unit selecting any one of a plurality of objects based on the contact position and a last contact position.

According to the embodiments of the present disclosure described above, it is possible to improve accuracy when selecting a user's intended object.

### BRIEF DESCRIPTION OF THE DRAWINGS

FIG. 1 is a diagram showing an example of a usage state of an information processing apparatus according to an embodiment of the present disclosure;

FIG. 2 is a diagram showing another example of a usage state of the information processing apparatus;

FIG. 3 is a diagram showing another example of a usage state of the information processing apparatus;

FIG. 4 is a block diagram showing an example functional configuration of the information processing apparatus;

FIG. 5 is a diagram showing an example layout of a plurality of buttons by the information processing apparatus;

FIG. 6 is a diagram showing one example of control of recognition regions by the information processing apparatus;

FIG. 7 is a diagram showing another example of control of the recognition regions by the information processing apparatus;

FIG. 8 is a diagram showing an example calculation of a correction amount for the recognition regions by the information processing apparatus;

FIG. 9 is a diagram showing an example correction of the recognition regions by the information processing apparatus;

FIG. 10 is a flowchart showing the flow of region control by the information processing apparatus;

FIG. 11 is a flowchart showing the flow of a selection operation by the information processing apparatus; and

FIG. 12 is a diagram useful in explaining a modification of the information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, in this specification and the drawings, in some cases a plurality of structural elements that have substantially the same function and structure are distinguished by different letters that have been appended to the same reference numerals. However, when it is not especially necessary to distinguish between such plurality of structural elements with effectively the same function and structure, only the same reference numerals are used.

Preferred embodiments of the present disclosure will now be described in the order indicated below.

### 1. Usage State of Information Processing Apparatus

### 2. Functions of Information Processing Apparatus

### 3. Operation of Information Processing Apparatus

### 4. Modification of Information Processing Apparatus

### 5. Conclusion

### 1. Usage State of Information Processing Apparatus

According to the present embodiment of the disclosure, it is possible to improve accuracy when selecting a user's intended object out of a plurality of objects displayed on a touch panel. For example, it is possible to improve the accuracy when selecting a user's intended object even when a user makes an input on a touch panel without looking at the touch panel and there is a large displacement between the object the user wishes to select and the position touched by the user or the user selects a position midway between a plurality of objects. In particular, according to the present embodiment of the disclosure, by focusing on the relationship between a last contact position on a touch panel and the present button being pressed, a technology for improving accuracy when selecting a user's intended object is realized.

Note that although an example where a device selects which button has been pressed by a user in order to select an object is described below, the selection of an object is not limited to the selection of a button pressed by the user and may be selection of an object aside from a button, such as an icon. The relationship between a last contact position on a touch panel and the present button being pressed will be described first. When a touch panel-equipped terminal (for example, a terminal of approximately the same size as a smartphone) is used as a controller, although there are exceptions, such terminal will usually be held in both hands near the base of the index fingers and operated using the thumbs.

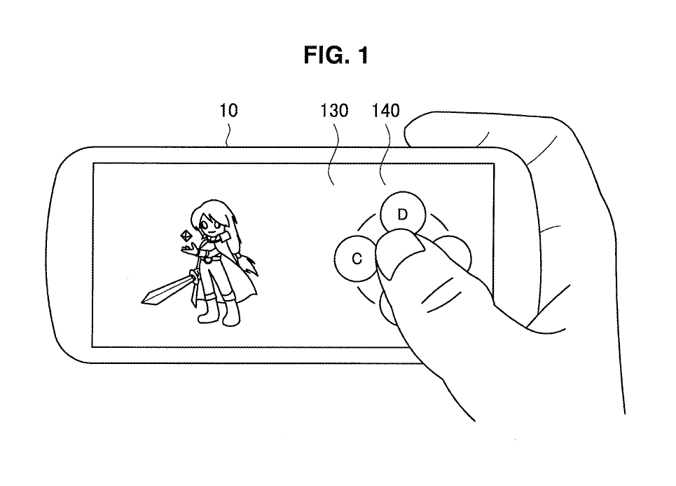

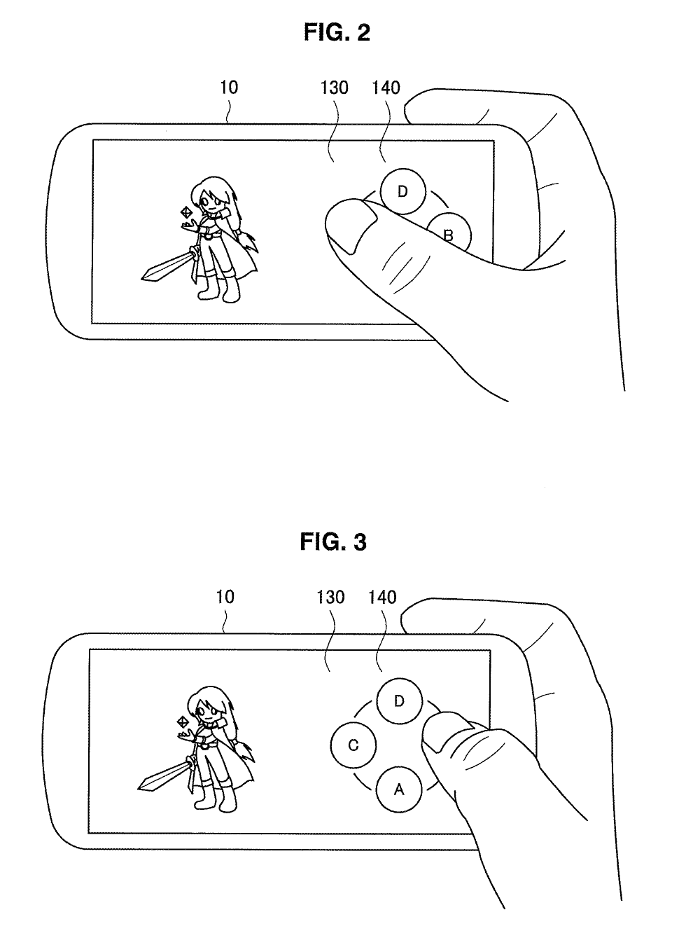

FIG. 1 is a diagram showing an example of a usage state of an information processing apparatus 10 according to an embodiment of the present disclosure. FIG. 2 is a diagram showing another example of a usage state of the information processing apparatus 10 according to the same embodiment. FIG. 3 is a diagram showing another example of a usage state of the information processing apparatus 10 according to the same embodiment. The information processing apparatus 10 is one example of a touch panel-equipped terminal and although an example where a touch panel 130 and a display unit 140 are provided on the information processing apparatus 10 is shown in FIGS. 1, 2, and 3, the touch panel 130 and the display unit 140 may be present outside the information processing apparatus 10. Also, although a state where the touch panel 130 and the display unit 140 are provided on top of one another is shown in FIGS. 1, 2, and 3, the touch panel 130 and the display unit 140 may be separate.

Also, although four buttons, button A, button B, button C, and button D, to be pressed by the user are displayed on the display unit 140 in the example in FIGS. 1, 2, and 3, the number of buttons is not especially limited to this. Also, as described above, it is also possible to display other objects aside from buttons on the display unit 140. In the present embodiment, an application is executed in accordance with the button pressed by the user and an execution result of the application is then displayed.

Although the execution result of the application is displayed on the display unit 140 in the example shown in FIGS. 1, 2, and 3, the execution result of the application may be displayed on a different display unit to the display unit 140. Although there are no particular limitations on the type of application, FIGS. 1, 2, and 3 show an example where the application is a game and a game execution screen is displayed on the display unit 140.

Here, as one example, as shown in FIG. 1, if a middle position of four buttons (the button A, the button B, the button C, and the button D) is contacted, it is difficult to determine which button the user was trying to press from merely information showing that the middle position was contacted. However, as shown in FIG. 2 for example, if the position of button C was contacted before the middle position is contacted, it is possible to determine that there is a high probability that the user was trying to press button B. Such determination is given for the reasons described below.

That is, when moving from the state shown in FIG. 2 to the state shown in FIG. 1, there is a large movement to the right in the left-right direction (x axis direction) and hardly any movement in the up-down direction (y axis direction). From such information, it is estimated that there is a high probability that the user was trying to press the button B positioned to the right of the button C. Meanwhile, as shown in FIG. 3, if the position of button B was contacted before the middle position is contacted, it is possible to determine that there is a high probability that the user was trying to press button C. Here, even if the user moves the input object by a distance with a large error, it is believed that the user will rarely make such a large error in the direction of movement of the input object. In this way, by considering the last contact position, it is possible to determine the button that the user was trying to press during a present contact more accurately.

This completes the description of the relationship between a last contact position and the present button being pressed. Next, the functions of the information processing apparatus 10 according to an embodiment of the present disclosure will be described.

### 2. Functions of Information Processing Apparatus

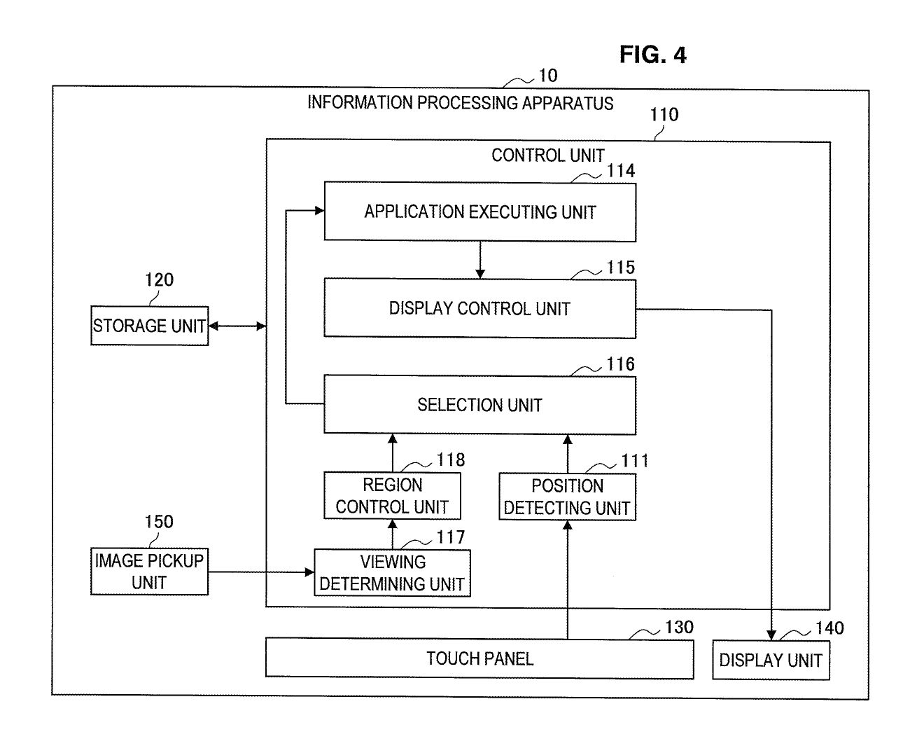

FIG. 4 is a block diagram showing an example functional configuration of the information processing apparatus 10 according to an embodiment of the present disclosure. As shown in FIG. 4, the information processing apparatus 10 includes a control unit 110, a storage unit 120, the touch panel 130, the display unit 140, and an image pickup unit 150. The control unit 110 includes a position detecting unit 111, an application executing unit 114, a display control unit 115, a selection unit 116, a viewing determining unit 117, and a region control unit 118.

Characteristics showing how the contact area and/or pressure change according to conditions such as whether the user is making a gentle operation, a sudden reactive operation, or a rapid pounding operation can also be given as such characteristic information. Note that such characteristic information can be obtained in advance by having the user play a simple mini game or the like and can be obtained from the normal operations made by the user.

The storage unit 120 uses a storage medium such as a semiconductor memory or a hard disk drive and stores programs and data for processing by the control unit 110. As one example, it is possible for the storage unit 120 to also store an application to be executed by the application executing unit 114. It is also possible for the storage unit 120 to store a history of contact positions or the like. Although the storage unit 120 is incorporated in the information processing apparatus 10 in the example shown in FIG. 4, the storage unit 120 may be constructed separately to the information processing apparatus 10.

The touch panel 130 detects a contact position of an input object. Such detection result is outputted to the control unit 110. As described above, the touch panel 130 may be included in the information processing apparatus 10 or may be present outside the information processing apparatus 10.

The position detecting unit 111 detects the contact position of the input object on the touch panel 130. More specifically, the contact position of the input object outputted from the touch panel 130 is detected by the position detecting unit 111. The contact position detected by the position detecting unit 111 is outputted to the selection unit 116 and is used to select the button pressed by the user.

The viewing determining unit 117 determines whether a part or all of a predetermined region including a plurality of buttons (for example, button A, button B, button C, and button D) is being viewed. As one example, the viewing determining unit 117 may determine whether a part or all of the predetermined region is being viewed by analyzing a picked-up image picked up by the image pickup unit 150 and detecting that the user's line of sight is orientated toward a part or all of the predetermined region.

Meanwhile, the viewing determining unit 117 may determine for example that a part or all of the predetermined region is not being viewed if it is detected that the user's line of sight is not orientated toward a part or all of the predetermined region. In place of the user's line of sight, the orientation of the user's face may be used. So long as a plurality of buttons are included, there are no particular limitations on the predetermined region, which may be the entire region of the display unit 140 or may be a region that is part of the region of the display unit 140 and includes a plurality of buttons.

The region control unit 118 controls recognition regions respectively associated with each of the plurality of buttons. As one example, the region control unit 118 may control the recognition regions respectively associated with each of the plurality of buttons based on the result of determination performed by the viewing determining unit 117. As one example, there are also cases where the user can make operations while looking at a part or all of the predetermined region including the plurality of buttons. Examples of such a case include situations where instantaneous operations are not necessary and where buttons are pressed in accordance with audio without looking at the buttons.

In such cases, there is a high probability that the displacement in the contact position will exhibit different tendencies between when a part or all of the predetermined region is being viewed and when such region is not being viewed. This means that by controlling the recognition regions associated with each of the plurality of buttons according to whether a part or all of the predetermined region is being viewed, it is possible to improve the accuracy when selecting the user's intended button. In more detail, if a part or all of the predetermined region is not being viewed, the recognition regions associated with each of the plurality of buttons are moved, but if a part or all of the predetermined region is being viewed, the recognition regions associated with each of the plurality of buttons do not have to be moved.

Also, if a predetermined time (for example, five seconds) has elapsed from the last contact, it is expected that the last contact will have less influence on the present pressing of a button. For this reason, the region control unit 118 may determine whether the predetermined time has elapsed from the last contact and control the recognition regions associated with each of the plurality of buttons if such predetermined time has not elapsed from the last contact.

Meanwhile, if such predetermined time has elapsed from the last contact, the region control unit 118 does not have to control the recognition regions associated with each of the plurality of buttons. By carrying out such control, it is possible to improve the accuracy of determining the button that the user is trying to press. Note that there are no particular limitations on the predetermined time mentioned here.

The selection unit 116 selects any one of the plurality of buttons based on the contact position detected by the position detecting unit 111 (hereinafter sometimes referred to as the “present contact position”) and the contact position detected the last time by the position detecting unit 111 (hereinafter sometimes referred to as the “last contact position”). The selected button is outputted to the application executing unit 114 as a button pressed by the user. More specifically, the respective positions of the plurality of buttons on the touch panel 130 may be set by an operating system or may be set by an application.

The selection unit 116 selects one of the plurality of buttons based on the set positions of the respective buttons, the present contact position, and the last contact position. As one example, the selection unit 116 selects a button associated with a recognition region to which the contact position detected by the position detecting unit 111 belongs. In addition, the selection unit 116 may carry out calibration based on a history of contact positions and select any one of the plurality of buttons based on the result of the calibration.

The application executing unit 114 executes an application based on the button selected by the selection unit 116. As one example, in the case shown in FIGS. 1, 2, and 3, part of the executed application may differ when the button A has been selected and when the button B has been selected by the selection unit 116. As described above, there are no particular limitations on the type of application. The application executing unit 114 outputs the execution result of the application to the display control unit 115.

The display control unit 115 controls the display unit 140 so that various buttons are displayed on the display unit 140. In the example shown in FIGS. 1, 2, and 3, the button A, the button B, the button C, and the button D are displayed by the display unit 140. Also, based on the execution result outputted from the application executing unit 114, the display control unit 115 may control the display unit 140 so that an application execution screen is displayed by the display unit 140. Note that as described above, the application execution screen may be displayed by a different display unit to the display unit 140.

In accordance with control by the display control unit 115, the display unit 140 displays various buttons. Also in accordance with control by the display control unit 115, the display unit 140 may display an application execution screen. However, the application execution screen may be displayed by a different display unit to the display unit 140. As described above, the display unit 140 may be provided in the information processing apparatus 10 or may be present outside the information processing apparatus 10. Note that the display unit 140 is constructed for example of an LCD (Liquid Crystal Display) or an organic LE (ElectroLuminescence) display apparatus.

The image pickup unit 150 picks up an eye region or a face region of the user and outputs a picked-up image obtained by the image pickup to the viewing determining unit 117. Note that although an example where the image pickup unit 150 is provided in the information processing apparatus 10 is shown in FIG. 4, the image pickup unit 150 may be present outside the information processing apparatus 10. The image pickup unit 150 may also be omitted altogether.

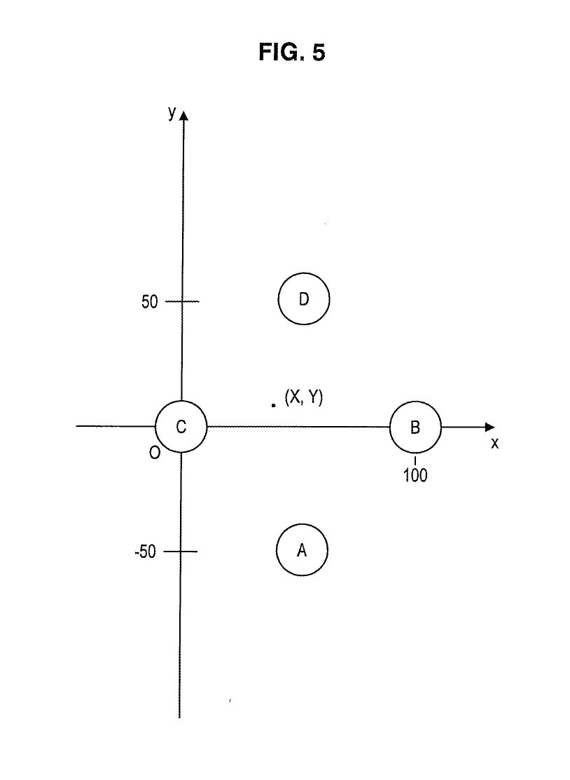

FIG. 5 is a diagram showing an example layout of a plurality of buttons by the information processing apparatus 10 according to the present embodiment. FIG. 5 shows an example of coordinate axes (an x axis and a y axis) set on the touch panel 130 for a case where a plurality of buttons are laid out as shown in FIGS. 1, 2, and 3. The contact position of the input object is shown as (X, Y). Although the position of the button A is (50, −50), the position of the button B is (100, 0), the position of the button C is (0, 0), and the position of the button D is (50, 50) in the example shown in FIG. 5, the setting of the coordinate axes is not especially limited to such.

One example of control of the recognition regions by the region control unit 118 will now be described in detail. Here, a case where x and y coordinates are set on the touch panel 130 as shown in FIG. 5 will be described as one example. However, the setting of the x and y coordinates is not especially limited to such.

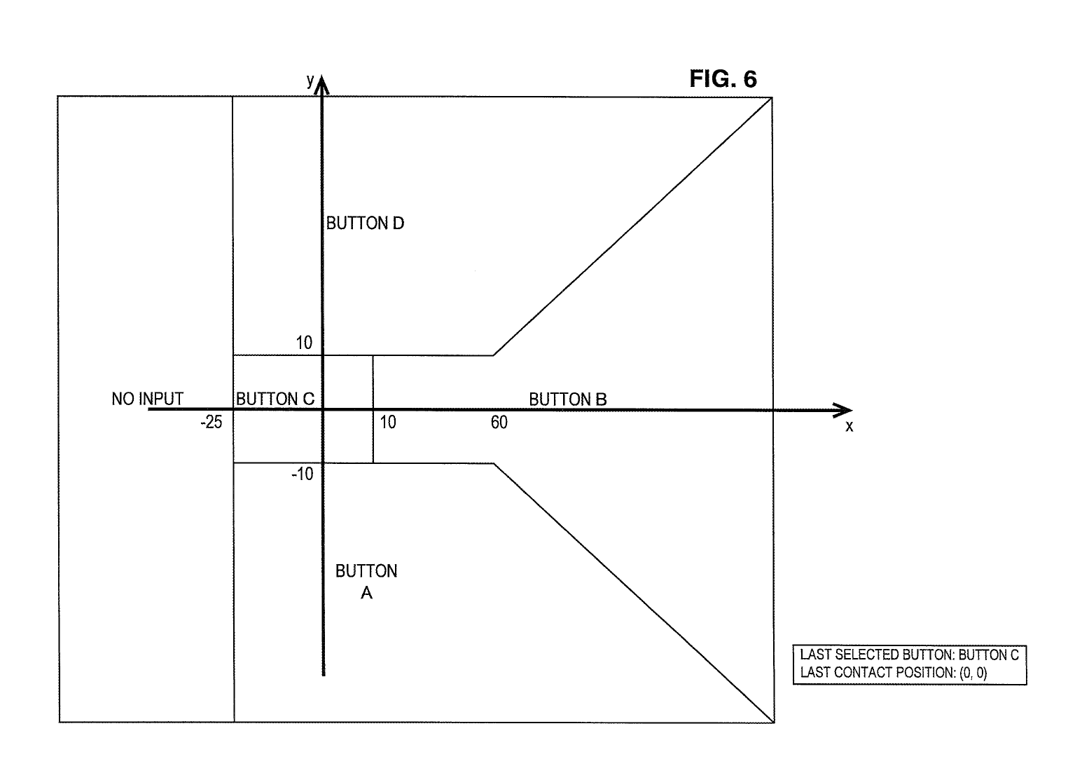

FIG. 6 is a diagram showing one example of control of the recognition region by the information processing apparatus 10 according to the present embodiment of the disclosure. First, the region control unit 118 sets the recognition regions associated with each of the plurality of buttons. As one example, the region control unit 118 sets the recognition regions associated with each of the plurality of buttons based on the button selected the last time. In the example shown in FIG. 6, the recognition regions associated with each of the plurality of buttons (the button A, the button B, the button C, and the button D) are set by the region control unit 118 based on the position (0, 0) of the button C selected the last time.

Although the recognition regions may be set in any way with the position of the button selected the last time as a standard, as one example it is possible to set recognition regions that are biased. As one example, if the user consecutively selects the same button, since the operation will continue without changing the contact position, it is believed that there will be little difference between the last contact position and the present contact position. This means that if the present contact position is a midpoint between the last selected button and a neighboring button, there is an extremely high probability that the user will have deliberately shifted the contact position, which means that there is a high probability that the button that the user presently wishes to press differs to the button selected the last time. For this reason, the region control unit 118 may set the recognition regions associated with each of the plurality of buttons so that a midpoint between the button selected the last time and a neighboring button is included in the recognition region associated with such neighboring button.

In the example in FIG. 6, the region control unit 118 sets the recognition regions associated with each of button C and button B so that a midpoint (50, 0) between the button C (0, 0) that was selected the last time and the button B (100, 0) neighboring the button C that was selected the last time is included in the recognition region associated with the neighboring button B (100, 0).

In the same way, in the example shown in FIG. 6, the region control unit 118 sets the recognition regions associated with each of button C and button D so that a midpoint (25, 25) between the button C (0, 0) that was selected the last time and the button D (50, 50) neighboring the button C that was selected the last time is included in the recognition region associated with the neighboring button D (50, 50).

Also, for the example shown in FIG. 6, the region control unit 118 sets the recognition regions associated with each of button C and button A so that a midpoint (25 ,−25) between the button C (0, 0) that was selected the last time and the button A (50, −50) neighboring the button C that was selected the last time is included in the recognition region associated with the neighboring button A (50,−50).

Note that the region control unit 118 may set the recognition regions associated with each of the plurality of buttons based on the button selected the last time. In the example shown in FIG. 6, the button C was selected the last time. In such case, the region control unit 118 may set the recognition regions associated with each of the plurality of buttons based on the button C selected the last time.

Although the region control unit 118 controls the recognition regions set as described above, it is also possible to control the recognition regions associated with each of the plurality of buttons based on the last contact position, for example. For example, the region control unit 118 may move the recognition regions associated with each of the plurality of buttons in parallel by a displacement of the last contact position with the position of the button selected the last time as a standard.

In the example shown in FIG. 6, since the button C (0, 0) was selected the last time and the last contact position was also the button C (0, 0), the displacement of the last contact position with the position of the button selected the last time as a standard is (0, 0). Accordingly, the region control unit 118 does not move the recognition regions associated with each of the plurality of buttons in parallel.

Next, another example of control by the region control unit 118 will be described in detail. When doing so, an example of control of the recognition regions set as described above is described. However, there are no particular limitations on the setting of the recognition regions.

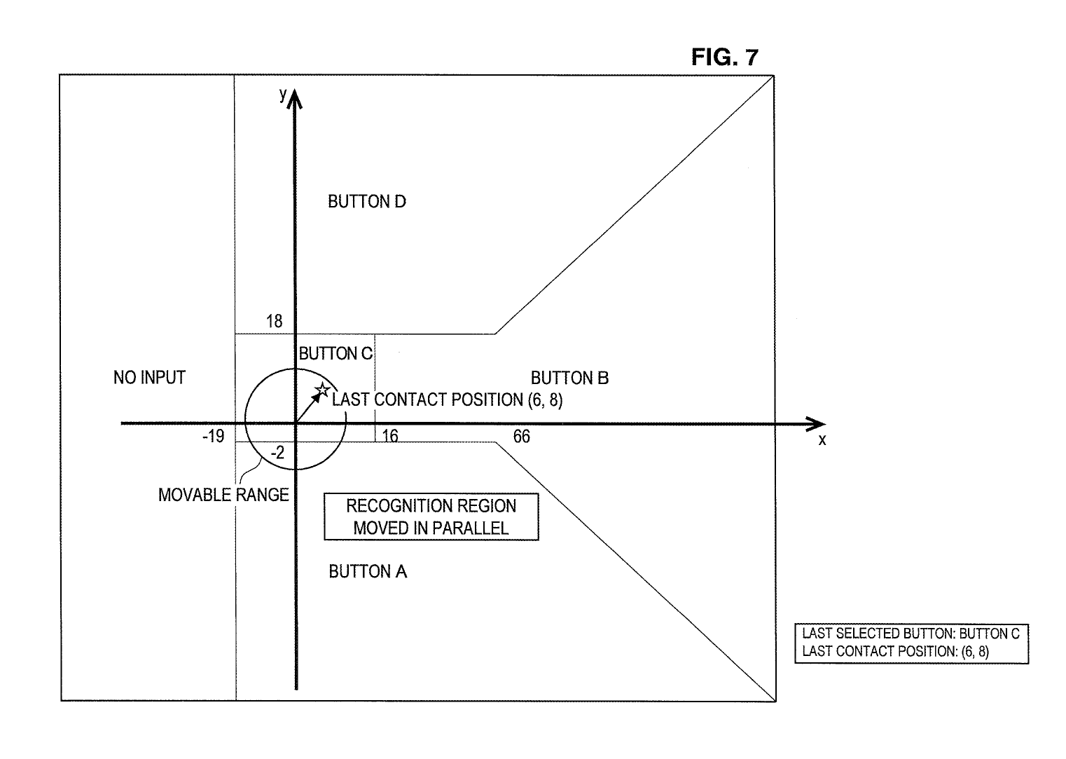

FIG. 7 is a diagram showing another example of control of the recognition regions by the information processing apparatus 10 according to the present embodiment of the disclosure. In the example in FIG. 7, the region control unit 118 moves the recognition regions associated with each of the plurality of buttons in parallel by the displacement of the last contact position (6, 8) with the last selected button C (0, 0) as a standard. However, the control of the recognition regions based on the last contact position is not limited to this example.

For example, the distance by which the regions are moved in parallel may be a value produced by multiplying the displacement of the last contact position with the position of the last selected button as a standard by a predetermined coefficient. For example, if the predetermined coefficient is set at “0.5”, the recognition regions associated with each of the plurality of buttons are moved in parallel by (3, 4). By using such predetermined coefficient, it is possible to prevent the recognition regions associated with each of the plurality of buttons from becoming largely displaced from their original positions while still giving consideration to the last contact position.

Since the predetermined coefficient may be influenced by the characteristics of how the buttons are laid out and characteristics of how the user presses a button, there is the possibility that an optimal value may not be universally decided. However, if a suitable value is set as the specified coefficient, this should improve the accuracy when determining the selection of a button. Control of the recognition regions based on the last contact position may change the forms of the recognition regions, may change the sizes of the recognition regions, and may change the orientations of the recognition regions.

However, there is the possibility that the positions of the recognition regions will be moved in parallel due to a position displaced from the position of the button to be selected being consecutively touched, resulting in the positions of the recognition regions becoming far from their original positions. In such case, there is the possibility that a determination will be made contrary to the user's intention. For this reason, it is preferable to provide an upper limit (in the example shown in FIG. 7, the movable range) for the range in which the recognition regions can be moved in parallel.

More specifically, when controlling the recognition regions associated with each of the plurality of buttons, the region control unit 118 may limit the range of movement of the recognition regions associated with each of the plurality of buttons to within the movable range. Since the movable range is influenced by the characteristics of how the buttons are laid out and characteristics of how the user presses a button, there is the possibility that an optimal range may not be universally decided. However, if a suitable value is set as the movable range, this should improve the accuracy when determining the selection of a button.

This completes the description of control of the recognition regions. By carrying out such control of the recognition regions, it is possible to improve the accuracy when selecting the user's intended button. In addition, as described above, it is also possible to improve the accuracy of determinations by using characteristic information for an individual user and/or characteristic information for various usage states acquired by carrying out calibration. That is, the region control unit 118 is capable of correcting the recognition regions associated with each of the plurality of buttons based on a history of contact positions.

The history of contact positions corresponds to a history of contact positions detected in the past by the position detecting unit 111. As one example, the region control unit 118 may correct the recognition regions associated with each of the plurality of buttons based on an average value of the displacement between positions contacted in the past and the objects selected by such contact. Such correction may be carried out for each button that has been selected by last contact.

In more detail, as one example, if there is one or a plurality of contact positions that has/have been detected in the past, the region control unit 118 may calculate a displacement between an average value of such one or plurality of contact positions and the positions of the buttons selected by such contact as a correction amount and carry out correction by shifting the contact position (X, Y) by such correction amount.

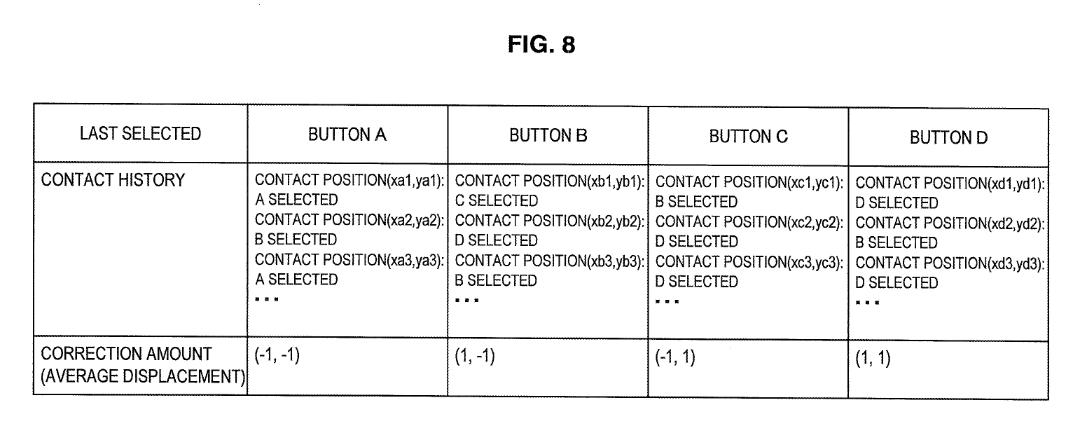

FIG. 8 is a diagram showing an example calculation of a correction amount for the recognition regions by the information processing apparatus 10 according to the present embodiment of the disclosure. In the example shown in FIG. 8, the region control unit 118 calculates, for each button selected by a last contact, the displacement between the average value of the one or plurality of contact positions and the position of the button selected by such contact and sets such displacement as the correction amount (or “average displacement”). The region control unit 118 may correct the recognition regions associated with each of the plurality of buttons in accordance with such correction amount.

As one example, the correction amount may be set at an amount produced by multiplying the displacement by a specified ratio. If a specified ratio is used, it is possible to prevent the recognition regions associated with each of the plurality of buttons from becoming largely displaced from their original positions while still giving consideration to the last contact positions.

Since the predetermined ratio is influenced by the characteristics of how the buttons are laid out and characteristics of how the user presses a button, there is the possibility that an optimal value may not be universally decided. However, if a suitable value is set as the predetermined ratio, this should improve the accuracy when determining the selection of a button. Correction of the recognition regions may change the forms of the recognition regions, may change the sizes of the recognition regions, and may change the orientations of the recognition regions.

Note that such characteristic information can be obtained in advance by having the user play a simple mini game or the like or can be obtained from the normal operations made by the user. Also, instead of average values, maximum values and minimum values may be used. In the same way as when the respective recognition regions are controlled, by providing an upper limit (for the example shown in FIG. 8, the movable range) for the movable range of the parallel movement of the recognition regions, it is possible to reduce the possibility that a determination will be made contrary to the user's intention.

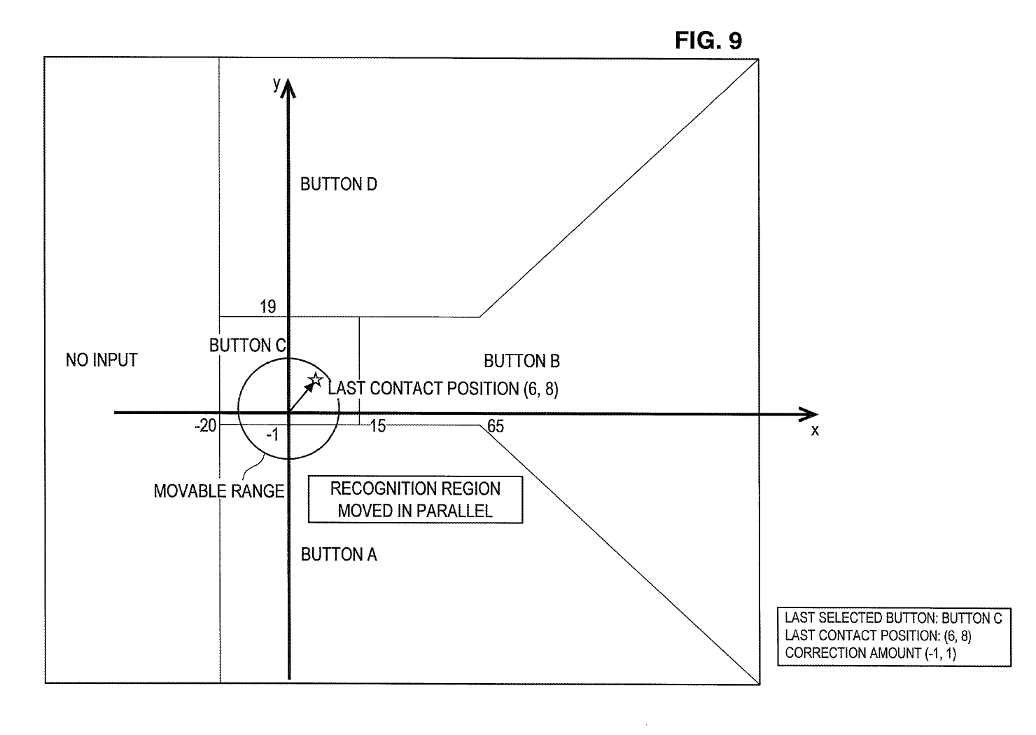

FIG. 9 is a diagram showing an example correction of the recognition regions by the information processing apparatus 10 according to the present embodiment of the disclosure. In this example, a situation is imagined where the region control unit 118 acquired the correction amount (−1, 1) for a case where the button selected by the last contact is the button C (see FIG. 8). As shown in FIG. 9, the region control unit 118 may move the recognition regions shown in FIG. 7 in parallel by the correction amount (−1, 1).

This completes the description of the functions of the information processing apparatus 10 according to the present embodiment of the disclosure. Next, the operation of the information processing apparatus 10 according to the present embodiment will be described. First, the flow of region control by the information processing apparatus 10 according to the present embodiment will be described.

### 3. Operation of Information Processing Apparatus

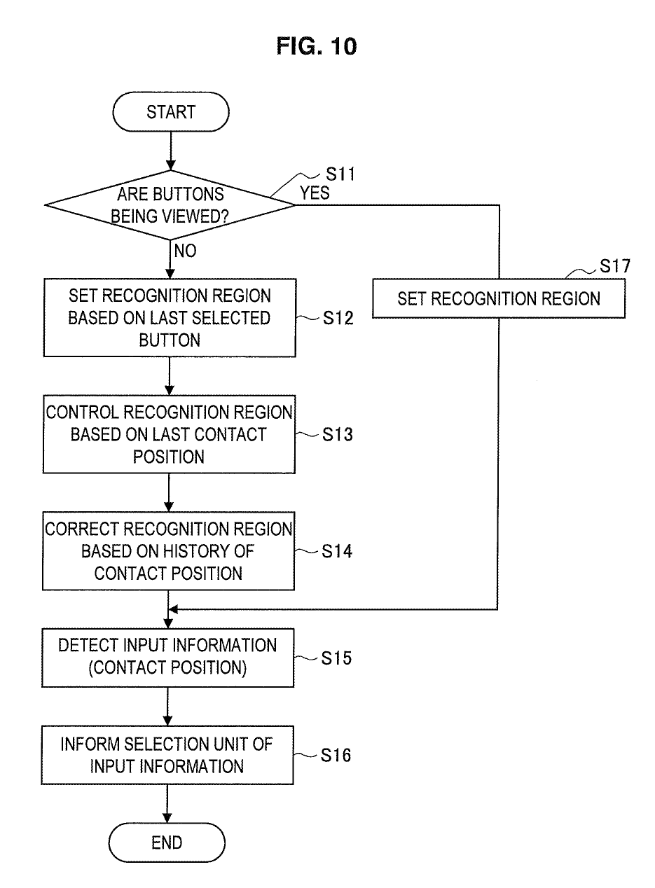

FIG. 10 is a flowchart showing the flow of region control by the information processing apparatus 10 according to the present embodiment of the disclosure. Note that since FIG. 10 merely illustrates one example of the flow of region control by the information processing apparatus 10, the region control by the information processing apparatus 10 is not limited to the flow of operations shown in FIG. 10.

First, the viewing determining unit 117 determines whether the user is looking at the buttons (S11). The “buttons” referred to here correspond to one example of a part or all of the predetermined region described above. If the viewing determining unit 117 determines that the user is looking at the buttons (“Yes” in S11), the recognition regions are set by the region control unit 118 (S17) and the operation proceeds to S15. The recognition regions set here may be recognition regions that are not biased. Meanwhile, if the viewing determining unit 117 determines that the user is not looking at the buttons (“No” in S11), the region control unit 118 sets the recognition regions based on the last selected button (S12). The region control unit 118 then controls the recognition regions based on the last contact position (S13).

After this, the region control unit 118 corrects the recognition regions based on the history of the contact position (S14). The position detecting unit 111 detects the input information (contact position) (S15) and the position detecting unit 111 informs the selection unit 116 of the input information (S16). After the selection unit 116 has been informed of the input information, the operation advances to the selection operation by the information processing apparatus 10.

This completes the description of the flow of region control by the information processing apparatus 10 according to the present embodiment of the disclosure. A selection operation by the information processing apparatus 10 according to the present embodiment of the disclosure will be described next.

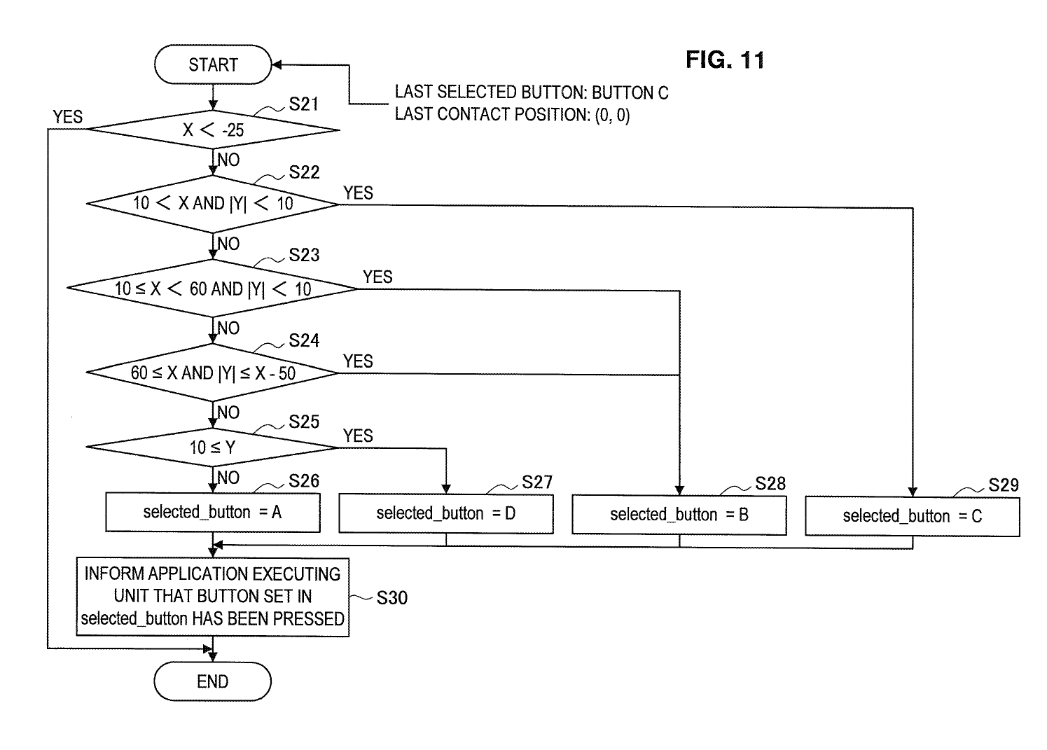

FIG. 11 is a flowchart showing the flow of a selection operation by the information processing apparatus 10 according to the present embodiment of the disclosure. Note that the operation shown in FIG. 11 shows a button selection operation carried out after controlling the recognition regions as shown in FIG. 6 for a case where the button C was selected the last time and the last contact position is (0, 0). Accordingly, this merely shows one example of the flow of region control by the information processing apparatus 10, and the region control by the information processing apparatus 10 is not limited to the flow of operations shown in FIG. 10.

First, if the X value out of the contact position (X, Y) indicated by the position detecting unit 111 is smaller than “−25” (“Yes” in S21), the selection unit 116 ends the operation without informing the application executing unit 114 of the pressing of a button. Meanwhile, if the X value is at least “−25” (“No” in S21), the selection unit 116 proceeds to S22.

After this, if the conditions that 10<X and |Y|<10 are satisfied (“Yes” in S22), the selection unit 116 sets the button C in the variable selected_button and then proceeds to S30. Meanwhile, if such conditions are not satisfied (“No” in S22), the selection unit 116 proceeds to S23.

Next, if the conditions “10≦X<60” and “|Y|<10” are satisfied (“Yes” in S23), the selection unit 116 sets the button B in the variable selected_button and then proceeds to S30. Meanwhile, if such conditions are not satisfied (“No” in S23), the selection unit 116 proceeds to S24.

After this, if the conditions “X≦60” and “|Y|<X−50” are satisfied (“Yes” in S24), the selection unit 116 sets the button B in the variable selected_button and then proceeds to S30. Meanwhile, if such conditions are not satisfied (“No” in S24), the selection unit 116 proceeds to S25.

Next, if the condition “10≦Y” is satisfied (“Yes” in S25), the selection unit 116 sets the button D in the variable selected_button and then proceeds to S30. Meanwhile, if the condition is not satisfied (“No” in S25), the selection unit 116 proceeds to S26.

After this, the selection unit 116 sets the button A in the variable selected_button and proceeds to step S30. The selection unit 116 informs the application executing unit 114 that the button set in the variable selected_button has been pressed (S30). This completes the selection operation, and after the selection operation has been completed, the application executing unit 114 executes an application based on the received information.

This completes the description of the flow of a selection operation by the information processing apparatus 10 according to the present embodiment of the disclosure. Next a modification of the information processing apparatus 10 according to the present embodiment of the disclosure will be described.

### 4. Modification of the Information Processing Apparatus

Here, although in many cases operations using a touch panel are made using a single finger, it is also possible to press a plurality of buttons using a plurality of fingers. As one example, it would be conceivable for a user to simultaneously press different buttons with his/her index finger and middle finger. In such a situation also, although there are cases where the contact positions are displaced, it is possible to correct the recognition according to the relative positional relationship between the two fingers.

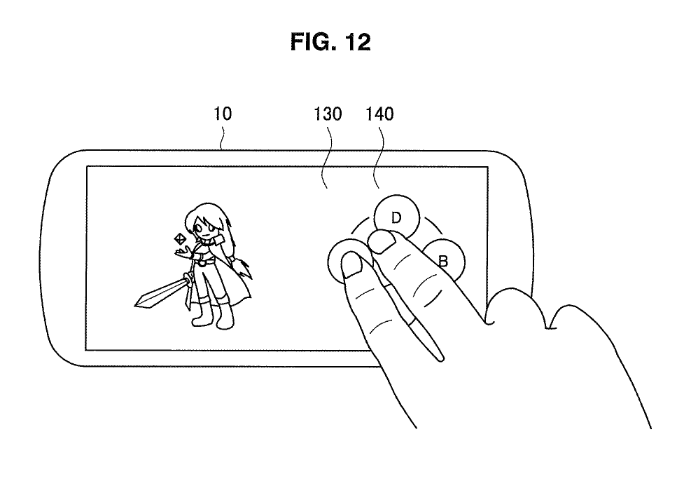

FIG. 12 is a diagram useful in explaining a modification of the information processing apparatus 10 according to an embodiment of the present disclosure. As one example, assume that on the touch panel 130 shown in FIG. 12, a position between the button C and the button D (in more detail, a position closer to the button C than a middle position between the button C and the button D) and the position of the button C have been simultaneously contacted. At this time, the region control unit 118 determines that the user is trying to simultaneously press the button C and the button D with two fingers and may correct the displacement. Such determination is reached according to the reasoning described below.
Since the position of the button C is being contacted on the touch panel 130, there is a high probability that the user is trying to press the button C.
Since two positions are being contacted on the touch panel 130, there is a high probability that the user is trying to press two different buttons.
Since the position between the button C and the button D (the position closer to the button C than the middle position between the button C and the button D) is positioned above and to the right of the position pressed by the other finger (i.e., the position of the button C), there is a high probability that the user is trying to press a button above and to the right of the button C.

Accordingly, although the selection unit 116 is described above as selecting any one of a plurality of buttons based on the contact position detected by the position detecting unit 111 and the last contact position detected by the position detecting unit 111, it is also possible for the selection unit 116 to use another contact position detected by the position detecting unit 111 in place of the last contact position. That is, the selection unit 116 may select any one of the plurality of buttons based on two contact positions detected by the position detecting unit 111.

### 5. Conclusion

As described above, according to an embodiment of the present disclosure there is provided the information processing apparatus 10 including the position detecting unit 111 that detects the contact position of an input object on the touch panel 130 and the selection unit 116 that selects any one of a plurality of objects based on the contact position and the last contact position.

With the above configuration, since the last contact position is also considered when selecting any one of a plurality of objects, it is possible to improve the accuracy when selecting the user's intended object. If the user operates the touch panel without looking at the objects themselves, for example, there is a high probability that the user's intended object will be selected even if a position displaced from a recognition region is touched. A further effect is expected in that it also becomes unnecessary for the user to momentarily look at the controller when making operations on a touch panel.

It should be understood by those skilled in the art that various modifications, combinations, sub-combinations and alterations may occur depending on design requirements and other factors insofar as they are within the scope of the appended claims or the equivalents thereof.

The steps in the operation of the information processing apparatus 10 according to the embodiment described above also do not have to be executed in a time series in the order indicated in the flowchart. For example, the steps in the operation of the information processing apparatus 10 may be executed in a different order to the order indicated in the flowchart or may be executed in parallel.

It is also possible to generate a computer program for causing hardware, such as a CPU, ROM, and RAM incorporated in the information processing apparatus 10, to realize the same functions as the configuration of the information processing apparatus 10 described above. A storage medium that stores such computer program may also be provided.

Additionally, the present technology may also be configured as below.

(1) An information processing apparatus including:
a position detecting unit detecting a contact position at which an input object has touched a touch panel; and
a selecting unit selecting any one of a plurality of objects based on the contact position and a last contact position.

(2) The information processing apparatus according to (1), further including:
a region control unit setting a recognition region associated with each of the plurality of objects,
wherein the selecting unit selects an object associated with a recognition region to which the contact position belongs.

(3) The information processing apparatus according to (2),
wherein the region control unit controls the recognition region associated with each of the plurality of objects based on a last contact position.

(4) The information processing apparatus according to (2) or (3), further including:
a viewing determining unit determining whether a part or all of a predetermined region including the plurality of objects is being viewed,
wherein the region control unit controls the recognition region associated with each of the plurality of objects based on a result of determination performed by the viewing determining unit.

(5) The information processing apparatus according to (2) or (3),
wherein, when controlling the recognition region associated with each of the plurality of objects, the region control unit is configured to limit a moving range of the recognition region associated with each of the plurality of objects to a movable range.

(6) The information processing apparatus according to (1),
wherein the region control unit determines whether a predetermined time has elapsed from a last contact and when the predetermined time has not elapsed from the last contact, the region control unit is configured to control the recognition region associated with each of the plurality of objects.

(7) The information processing apparatus according to any one of (2) to (6),
wherein the region control unit corrects the recognition region associated with each of the plurality of objects based on a history of the contact position.

(8) The information processing apparatus according to (7),
wherein the region control unit corrects the recognition region associated with each of the plurality of objects based on an average value of displacements between positions previously contacted and objects selected by the contact.

(9) The information processing apparatus according to any one of (2) to (8),
wherein the region control unit sets the recognition region associated with each of the plurality of objects based on a last selected object.

(10) The information processing apparatus according to (9),
wherein the region control unit sets the recognition region associated with each of the plurality of objects in a manner that a midpoint between the last selected object and an object neighboring the last selected object is included in a recognition region associated with the neighboring object.

(11) An information processing method including:
detecting a contact position at which an input object has touched a touch panel; and
selecting any one of a plurality of objects based on the contact position and a last contact position.

(12) A program for causing a computer to function as an information processing apparatus, the information processing apparatus including
a position detecting unit detecting a contact position at which an input object has touched a touch panel; and
a selecting unit selecting any one of a plurality of objects based on the contact position and a last contact position.

The present disclosure contains subject matter related to that disclosed in Japanese Priority Patent Application JP 2012-021892 filed in the Japan Patent Office on Feb. 3, 2012, the entire content of which is hereby incorporated by reference.

What is claimed is:

1. An information processing apparatus comprising:
a position detecting unit detecting a contact position at which an input object has touched a touch panel; and
a selecting unit selecting any one of a plurality of objects based on the contact position and a last contact position.

2. The information processing apparatus according to claim 1, further comprising:
a region control unit setting a recognition region associated with each of the plurality of objects,
wherein the selecting unit selects an object associated with a recognition region to which the contact position belongs.

3. The information processing apparatus according to claim 2,
wherein the region control unit controls the recognition region associated with each of the plurality of objects based on a last contact position.

4. The information processing apparatus according to claim 2, further comprising:
a viewing determining unit determining whether a part or all of a predetermined region including the plurality of objects is being viewed,
wherein the region control unit controls the recognition region associated with each of the plurality of objects based on a result of determination performed by the viewing determining unit.

5. The information processing apparatus according to claim 2,
wherein, when controlling the recognition region associated with each of the plurality of objects, the region control unit is configured to limit a moving range of the recognition region associated with each of the plurality of objects to a movable range.

6. The information processing apparatus according to claim 1,
wherein the region control unit determines whether a predetermined time has elapsed from a last contact and when the predetermined time has not elapsed from the last contact, the region control unit is configured to control the recognition region associated with each of the plurality of objects.

7. The information processing apparatus according to claim 2,
wherein the region control unit corrects the recognition region associated with each of the plurality of objects based on a history of the contact position.

8. The information processing apparatus according to claim 7,
wherein the region control unit corrects the recognition region associated with each of the plurality of objects based on an average value of displacements between positions previously contacted and objects selected by the contact.

9. The information processing apparatus according to claim 2,
wherein the region control unit sets the recognition region associated with each of the plurality of objects based on a last selected object.

10. The information processing apparatus according to claim 9,
wherein the region control unit sets the recognition region associated with each of the plurality of objects in a manner that a midpoint between the last selected object and an object neighboring the last selected object is included in a recognition region associated with the neighboring object.

11. An information processing method comprising:
detecting a contact position at which an input object has touched a touch panel; and
selecting any one of a plurality of objects based on the contact position and a last contact position.

12. A program for causing a computer to function as an information processing apparatus, the information processing apparatus including
a position detecting unit detecting a contact position at which an input object has touched a touch panel; and
a selecting unit selecting any one of a plurality of objects based on the contact position and a last contact position.
